(19) United States
(12) Patent Application Publication
(10) Pub. No.: US 2006/0102023 A1
(43) Pub. Date: May 18, 2006

(54) Handicap square stencil

(76) Inventor: Carlos Rivera, Anaheim, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 10/979,503

(22) Filed: Nov. 2, 2004

(51) Int. Cl. B05C 17/06

(52) U.S. Cl. 101/127

(57) ABSTRACT

A stencil for painting a square of a predetermined size onto a parking lot surface is disclosed. The stencil comprises a pair of U-shaped frames that each include an elongated rectangular base member fixed to two elongated rectangular leg members so as to form the U-shaped frame. Each leg member includes an elongated hole formed generally parallel to the base member and proximate to the distal end thereof. A pair of coiled springs are included, each of which traverse the hole in one leg member of each frame, the springs thereby forming a pivotal hinge. As such, the frames may be pivoted around each other at their hinges to assume either a closed U-shaped position for carrying or storing, or an open position for laying flat on the parking lot surface. In the open position, the frames are in opposing positions, thereby forming a square shaped pattern therebetween for painting the square on the parking lot surface. A handle cut-out may be further included in each frame to facilitate carrying of the stencil when the stencil is in the closed position.

### FIELD OF THE INVENTION

The present invention relates generally to stencils for painting, and, more particularly, is directed towards a stencil for facilitating the painting of parking lots.

### DISCUSSION OF RELATED ART

Many jurisdictions require that handicapped parking stalls be marked in a particular manner so that all such handicapped parking stalls are consistently marked throughout the jurisdiction and are thereby readily identifiable. One common element in such markings is a blue square of a particular size, onto which a wheelchair image is stenciled in white letters. The blue square is typically mandated to be of a particular size, such as three feet square.

When using paint to mark parking lots with stripes, arrows, lane dividers, and the like, stencils are often used. However, templates for relatively large squares are typically rigid square frames that are bulky and difficult to handle. As a result, many parking lot painters use a number of rigid beams, such as standard two-by-fours, as a make shift stencil for painting the blue squares required for handicapped parking spaces. The squares that result are sometimes not either perfectly square or of the prescribed dimensions.

An example of one such parking lot stencil may be found in U.S. Pat. No. 5,980,664 to Wilson, Sr., on Nov. 9, 1999. The device disclosed in Wilson is used in the application of a permanent cement-like material so as to create a raised arrow design marking on a parking lot, and in the '664 reference the template taught for such use is for an arrow design. Permanent raised markings for parking lots are undesirable since the use of the parking lot, or the layout of the parking lot, often changes as vehicle sizes and regulations change, creating the need to remove what is essentially a permanently bonded marking. Moreover, such a mat, which is made from a flexible material, would be ill-suited for use in marking a relatively large square. The flexibility of such a material would likely permits tears to occur at the corners if it were used in the application of a large square, and if the walls of such a device were thickened in order to overcome this drawback the resulting stencil would be bulky and difficult to transport and maneuver.

Another example of a template for marking on pavement is disclosed in U.S. Pat. No. 5,519,940 to Brondfield on May 28, 1996. While such a device is primarily used for applying a basketball foul lane and key onto a pavement surface. The primary advantage of the device disclosed in Brondfield is its flexibility in making any number of different designs, since it is made up of a plurality of segments which may be placed so as to obtain a desired pattern. However, such a system is impractical for use in a large parking lot, which is the environment in which the present invention is to be used, since it takes an inordinate amount of time to piece together the desired square pattern. The present invention required very little amount of time, a minute, to set up the square for painting. Clearly, then, what is needed is a very simple to use, rigid and durable stencil for creating a square pattern of a prescribed size on a surface upon which the device lies. Such a needed device would allow speedy set-up and be easy to clean and transport. The present invention accomplishes these objectives.

### SUMMARY OF THE INVENTION

The present device is a stencil for painting a square of a predetermined size onto a parking lot surface. The stencil comprises a pair of U-shaped frames, preferably formed from ½ inch thick plastic stock or other rigid and durable material. Each frame includes an elongated rectangular base member, and two elongated rectangular leg members, which form the U-shaped frame.

Each leg member includes a hinge attachment means, formed within an elongated opening, formed proximate to the end of the leg member that is distal from the base member. A pair of hinge means, such as coiled springs, are included, each of which are attached to the hinge attachment means of one leg member of each frame. As such, the frames may be pivoted around each other at their respective hinge attachment means to assume either a closed, co-aligned U-shaped position for carrying or storing, or a coplanar open position for laying flat on the parking lot surface. In the open position, the frames are in opposing positions, thereby forming a square shaped pattern therebetween for painting the square on the parking lot surface.

A handle cut-out may be further included and formed proximate to the center of each base member of each frame such that when the stencil is in the closed position, the handle cut-outs of each frame become co-aligned. A user of the stencil is then able to hold the stencil by grasping both base members through the handle cut-outs when the stencil is in the closed position.

In use, the user carries the stencil from a truck or other storage area and places the stencil on the parking lot surface in the open position. The user then applies paint to the surface in the square area defined between the frames. Upon completion of the painting of the square area on the surface, the user then folds the stencil back into its closed position, and removes the stencil from the surface.

The present invention is a rigid and durable stencil for creating a square pattern of a prescribed size on a surface. The present device is inexpensive to manufacture, and allows for quick set-up and is easy to use, clean and transport. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective illustration of the invention, illustrating two U-shaped frames pivotally attached to each other;

FIG. 2 is a top plan view of the invention, illustrating a stencil of the invention in an open position as laying flat on a parking lot surface;

FIG. 3 is a partial perspective view of the hinged connection of the present invention, taken generally along lines 3-3 of FIG. 1; and

FIG. 4 is a side elevational view of the invention, illustrating the stencil in a closed position for carrying.

### DETAILED DESCRIPTION OF THE PREFERRED EMBODIMENT

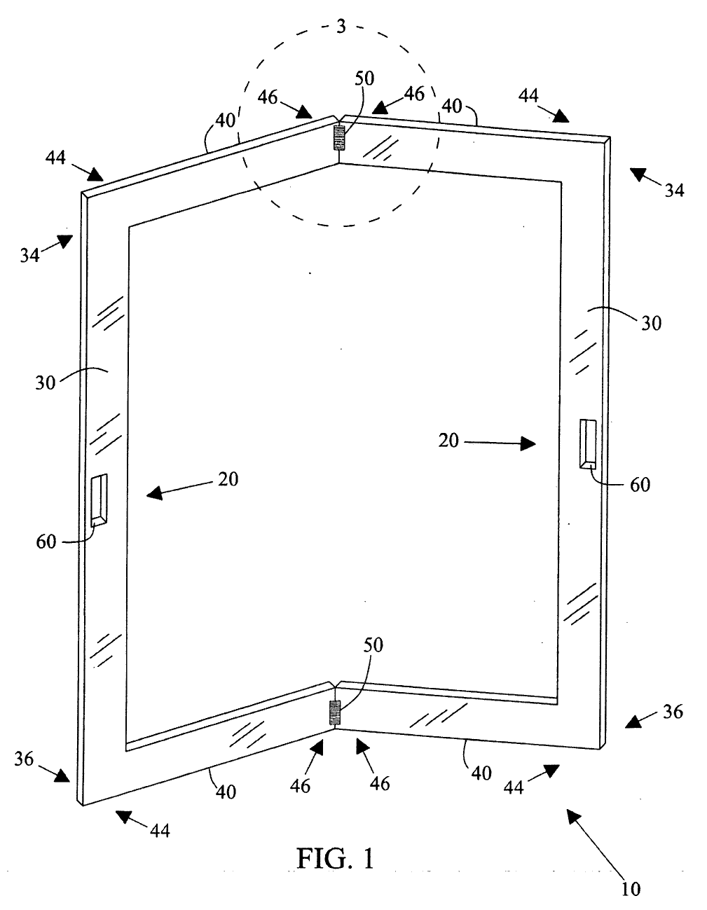

FIG. 1 illustrates a stencil 10 for painting a square of a predetermined size onto a parking lot surface 15. The stencil 10 comprises a pair of U-shaped frames 20, preferably formed from ½ inch thick plastic stock or other rigid and durable material.

Each frame 20 includes an elongated rectangular base member 30 with a first end 34 and a second end 36, and two elongated rectangular leg members 40. Each leg member 40 has a first end 44 and a second end 46. One leg member 40 is fixed orthogonally at its first end 44 to the first end 34 of each of the base members 30, and the other leg member 40 is fixed orthogonally at its first end 44 to the second end 36 of each of the base. members 30. As such, the leg members 40 and the base member 30 of each frame 20 are each coplanar, and the leg members 40 are co-aligned, thereby forming one of the U-shaped frame 20.

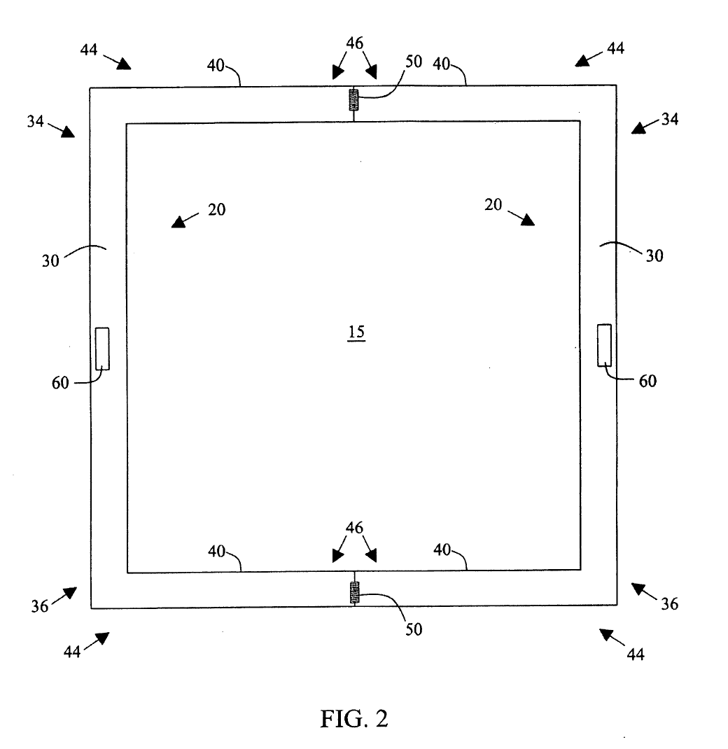

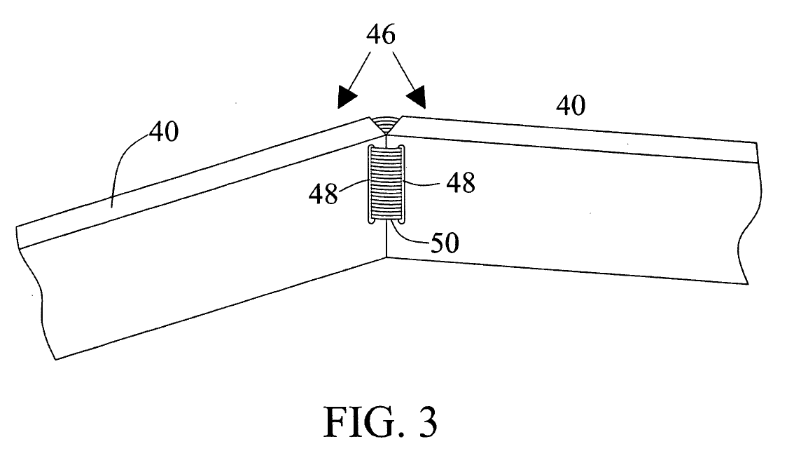

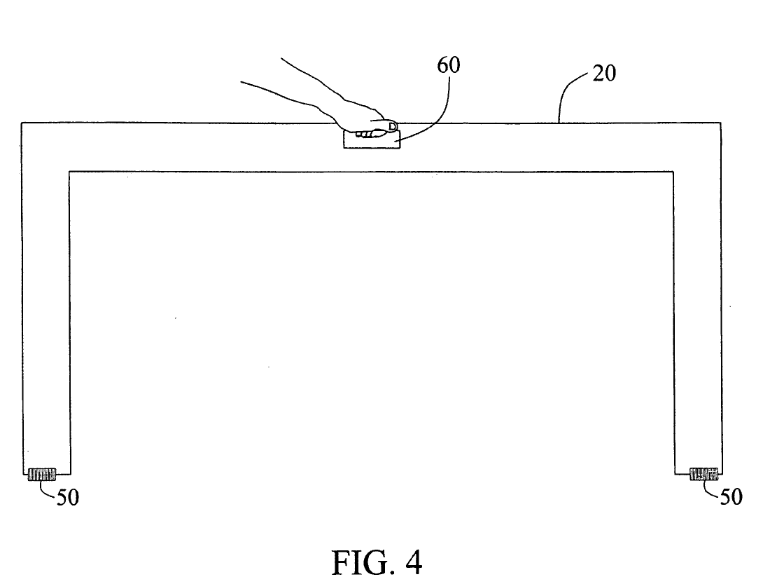

The second end 46 of each leg member 40 includes a hinge attachment means 48 formed therein (FIG. 3). A pair of hinges 50 are included, each of which are attached to the hinge attachment means 48 of one leg member 40 of each frame 20. As such, the frames 20 may be pivoted around each other at their respective pivotal connection means 48 to assume either a closed co-aligned U-shaped position for carrying or storing (FIG. 4), or a coplanar open position for laying flat on the parking lot surface 15 (FIG. 2). In the open position, the frames 20 are in opposing positions, thereby forming a square shaped pattern therebetween for painting the square on the parking lot surface 15.

The hinge attachment means 48 may simply be elongated holes formed through each leg member 40 proximate to the second ends 46 thereof. The holes, in such an embodiment, are generally parallel to the base member 30. The hinge means 50 is preferably a coiled spring traversing through the elongated holes of each of one leg member 40 of each frame 20 (FIG. 3). Such springs would not be used as the hinge mechanism 50 for their normal tensioning properties, but rather their durability and suitability as a hinge mechanism 50. Clearly any circular elements of such a size as to allow the free pivoting of the frames 20 with respect to each other would suffice as the hinge mechanism 50, provided that the elements were not so large as to prevent the second ends 46 of the leg members 40 from maintaining close proximity or actual contact with each other when the stencil 10 is in the open position as illustrated in FIG. 2. A hinge 50 with a diameter which is too large would result in a gap between the frames 20 when the stencil is in the open position 10, which is undesirable as paint would inadvertently be applied within the gap.

A handle 60 may be further included and may comprise an opening formed proximate to the center of each base member 30 of each frame 20 such that when the stencil 10 is in the closed position, the handle opening 60 of each frame become co-aligned. A user of the stencil 10 is then able to hold the stencil 10 by grasping both base members 30 through the handle opening 60 when the stencil 10 is in the closed position.

In use, the user carries the stencil 10 from a truck or other storage area (not shown), and places the stencil 10 on the parking lot surface 15 in the open position (FIG. 2). The user then applies paint to the surface 15 in the square area defined between the frames 20. The frames 20 are each wide enough, preferably at least three inches wide, to allow the speedy application of the paint to the surface 15 within the frames 20 without much risk of paint being inadvertently applied to the surface 15 outside of the stencil 10. Upon completion of the painting of the square area on the surface 15, the user then folds the stencil 10 back into its closed position (FIG. 4), and removes the stencil 10 from the surface 15. Any paint that was inadvertently applied to the frames 20 is retained within the folded frames 20, such that it does not contact other surfaces near where the stencil 10 is stored after use. Further, the plastic material of which the frames 20 are formed is preferably resistant to paint adhesion, and as such stray paint may be readily removed from the frames 20 if desired during clean-up. A Teflon-type surface coating or plastic material may be used for the frames 20, provided that the material is suitably rigid and durable.

While a particular form of the invention has been illustrated and described, it will be apparent that various modifications can be made without departing from the spirit and scope of the invention. For example, various materials, including wood, might be substituted for the plastic material for the frames 20. Likewise, plastic ties or other elements may be substituted for the preferred coiled springs for the hinge mechanism 50. Accordingly, it is not intended that the invention be limited, except as by the appended claims.

I claim:

1. A stencil for painting a square of a particular size onto a parking lot surface, comprising:
a pair of frames, each frame including an elongated rectangular base member having a first and a second end, and two elongated leg members, each leg member including a first end fixed orthogonally to opposing ends of the base member, the leg members and base member being coplanar and each leg member being co-aligned;
a pair of means for pivotally connecting said frames, each pivotal means attached to said second end of said leg members of each frame such that the frames may be pivoted around each other at their respective pivotal connection means having a closed co-aligned position for carrying, or a coplanar open position for laying flat on the parking lot surface, the opposing frames thereby forming a square-shaped pattern for painting the square.

2. A stencil for painting a square of a particular size onto a parking lot surface, comprising:
a pair of U-shaped frames, each frame including an elongated rectangular base member, and two elongated rectangular leg members, each leg member including first and second ends, said first end fixed orthogonally to opposing ends of the base member, elongated openings formed on the second end of each leg member the leg members, said base member being coplanar and each leg member being co-aligned; and
a pair of hinges, each received by said respective opening in said second end of each of said leg members, such that the frames may be pivoted around their respective hinges having a closed co-aligned U-shaped position for carrying, or a coplanar open position for laying flat on the parking lot surface, the opposing frames thereby forming a square shaped pattern for painting the square.

3. The stencil of claim 1 wherein said pivotal connection means is a coiled spring.

4. The stencil of claim 2 where a handle is formed proximate the center of each base member such that when the stencil is in the closed position the handle of each frame becomes co-aligned.
